(19) United States
(12) Patent Application Publication
(10) Pub. No.: US 2015/0379465 A1
(43) Pub. Date: Dec. 31, 2015

(54) WORK-DETAIL-DATA DISTRIBUTION SYSTEM AND METHOD FOR 2D-CODE-READING LP GAS WORK

(71) Applicant: NIPPON GAS CO., LTD., Tokyo (JP)

(72) Inventors: Shinji Wada, Tokyo (JP); Shingo Dekamo, Tokyo (JP)

(21) Appl. No.: 14/763,948

(22) PCT Filed: Jan. 30, 2014
(86) PCT No.: PCT/JP2014/000496

§ 371 Date: Jul. 28, 2015

(30) Foreign Application Priority Data
Jan. 31, 2013 (JP) 2013-017788

(51) Int. Cl. G06Q 10/08; G06Q 50/06

(52) U.S. Cl. CPC G06Q 10/0838; G06Q 50/06

(57) ABSTRACT

In LP gas business, when an operation is performed based on an operation list pre-distributed to an operator's mobile terminal, erroneous operations may be performed due to, for example, erroneous input of an identification number of an operation target facility (a gas meter, a supply facility, or the like) or a time lag between the time of operation list distribution and the time of performance of the operation. When an operation target facility is identified on the operation list, a two-dimensional code attached to an operation target facility installed at an operation site is read to prevent misrecognition of the operation target facility. Furthermore, at this time, operation detail data is distributed in real time.

### TECHNICAL FIELD

The present invention relates to an operation detail data distribution system for LP gas business based on loading of a two-dimensional code.

### BACKGROUND ART

LP gas is classified into imports from gas producing countries and domestic production including by-products from production processes of petroleum products. Import terminals where LP gas carried from gas producing countries by tankers is stored and petroleum refinery terminals are referred to as primary terminals. LP gas is loaded into domestic vessels or tank trucks at a primary terminal and shipped to secondary terminals that are transit stations for LP gas transportation which are located longshore or inland. Then, the LP gas carried to a secondary terminal is transported to LP gas filling stations in various locations (delivery bases), where gas cylinders are filled with the LP gas.

Gas cylinders filled with LP gas at each delivery base are delivered by deliverymen to customers such as general homes, housing complexes, and business offices. The relation between the gas container and the customer may be one-to-one or may correspond to the case of a housing complex where a plurality of customers uses one gas cylinder (that is, a one-to-many relation). Used gas cylinders at customer's homes are replaced with filled gas containers and are collected at the delivery base. Furthermore, for each delivery base, a fixed delivery area for which a deliveryman is responsible is set. The deliveryman visits the customers' homes in the delivery area to deliver gas cylinders to the customers, based on a delivery list.

The delivery list is created by predicting the amount of LP gas remaining in a gas cylinder and adjusting a delivery due date so as to prevent the shortage of gas in the gas cylinder, based on the actual amount of gas previously used by each customer, the result of meter reading of a gas meter at the customer's home (hereinafter referred to as a customer), an actual delivery count, and the like. Furthermore, the delivery list is created on a server computer and pre-downloaded into each deliveryman's mobile terminal.

Types of LP gas business include, besides delivery business, meter reading business for checking the amount of gas used and safety business for conducting periodic inspections of supply facilities such as the gas cylinder and consumption facilities such as a water heater installed in a customer's house, as specified by the relevant act. For these types of business, a meter reading list or a safety inspection list is created by adjusting the schedule date as is the case with the delivery business. Based on these lists, a meter reader or a safety inspector performs an operation. The delivery list, the meter reading list, and the safety inspection list are hereinafter collectively referred to as “operation lists”.

However, an operation based on the operation lists may lead to an error for the following reasons. For example, when a deliveryman inputs an identification number to the mobile terminal in order to identify a supply facility in the operation list as an operation target, an erroneous input maybe provided. Then, the deliveryman may perform delivery based on erroneous supply facility data (what is called misdelivery). Furthermore, a time lag between the time of delivery list creation and the time of actual delivery may lead to a change in delivery data. The deliveryman may perform the operation based on old data.

### SUMMARY OF INVENTION

### Technical Problem

The present invention has been developed in view of these problems. An object of the present invention is to provide a system and a method which allow prevention of misrecognition of an operation target facility (a gas meter, a supply facility, or the like) and which also allow real-time distribution of operation data on the LP gas business.

### Solution to Problem

To accomplish such an object, the present invention provides a method of loading a two-dimensional code and outputting operation detail data on LP gas business, the method including:

outputting operation list data that is operation schedule data on the LP gas business including a plurality of pre-downloaded and stored operation target data;

receiving one of the operation target data selected from the output operation list data by a user operation;

reading a two-dimensional code attached to an operation target facility and receiving the two-dimensional code as two-dimensional code data;

matching the selected operation target data against the received two-dimensional code data; and

a step of, when the selected operation target data and the received two-dimensional code data are correctly matched, outputting operation detail data that is detail data of the selected operation target data.

Furthermore, in the invention described in the preceding paragraph, the operation detail data is created after the selected operation target data and the received two-dimensional code data are correctly matched.

Additionally, the invention described in the second paragraph further includes a step of, when the selected operation target data and the received two-dimensional code data fail to be correctly matched, outputting information indicating that the selected operation target data and the received two-dimensional code data fail to be correctly matched.

In the invention described in the third paragraph, the two-dimensional code is a QR code (registered trademark).

### Advantageous Effects of Invention

As described above, according to the present invention, when an operation target facility (a gas meter, a supply facility, or the like) is identified on an operation list, the two-dimensional code attached to the operation target LP gas facility installed at an operation site is read to enable prevention of misrecognition of the operation target facility. Furthermore, at this time, the operation detail data can be distributed in real time. Additionally, reading the two-dimensional code enables a reduction in operation time compared to manual input.

### BRIEF DESCRIPTION OF DRAWINGS

FIG. 1 is a diagram depicting a network configuration according to one embodiment of the present invention;

FIG. 2 is a block diagram depicting a configuration of a mobile terminal according to the one embodiment of the present invention;

FIG. 3 is a diagram depicting an example of data stored in an operation list data storage unit according to the one embodiment of the present invention;

FIG. 4 is a diagram depicting an example of data stored in a two-dimensional code data storage unit according to the one embodiment of the present invention;

FIG. 5 is a diagram depicting an example of data stored in an operation detail data storage unit according to the present invention; and

FIG. 6 is a flowchart illustrating a process of distributing an operation list, loading a two-dimensional code, and downloading operation target data.

### DESCRIPTION OF EMBODIMENTS

A method and a system according to an embodiment of the present invention will be described in detail with reference to the attached drawings.

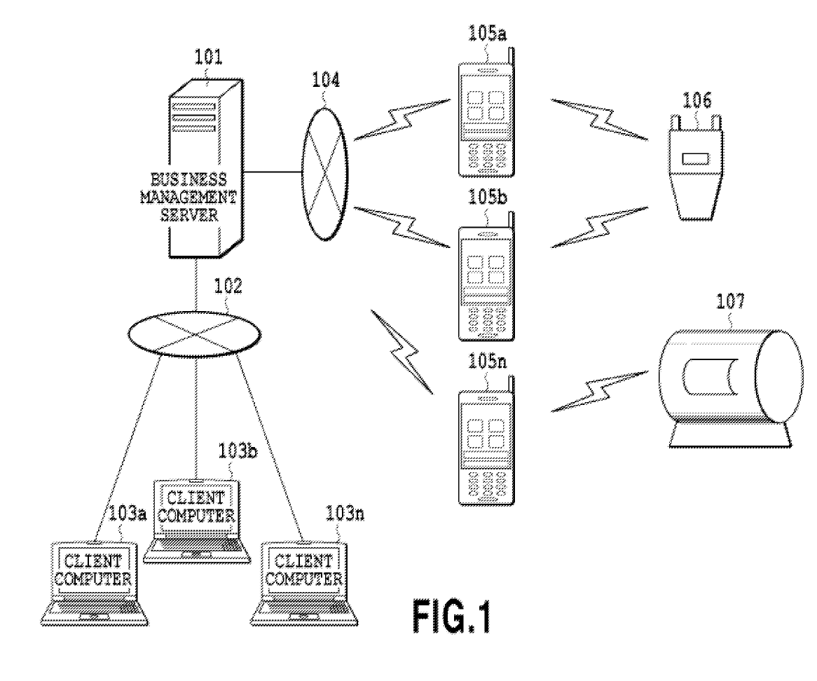

FIG. 1 is a diagram depicting network configuration according to the one embodiment of the present invention. In FIG. 1, an operation management server 101 located in, for example, data center is configured to communicate via a network 102 with a plurality of client computers 103a, 103b, . . . , 103n (hereinafter referred to as the “client computer 103”) located in respective sales offices. Furthermore, the operation management server 101 is configured to communicate with a plurality of mobile terminal 105a, 105b, . . . , 105n (hereinafter referred to as the “mobile terminal 105”) via a network 104. The mobile terminal is carried by, for example, a deliveryman who performs an operation. Furthermore, two-dimensional codes attached to a gas meter 106 and a supply facility 107 is loaded by the mobile terminal 105.

The business management server 101 creates a delivery list by predicting the amount of LP gas remaining in a gas cylinder and adjusting a delivery due date, based on the actual amount of gas previously used by each customer, the result of meter reading of a gas meter at the customer's home, and the actual delivery count. Furthermore, the business management server 101 adjusts meter reading due dates based on the last meter reading date to create a delivery list. The business management server 101 then adjusts a safety inspection due dates based on a legal term to create a safety inspection list. The delivery list, the meter reading list, and the safety inspection list are all lists of the next operation due date for each operation. Furthermore, the operation lists may be changed by a manager or the like via a client computer 103.

The operation list created is distributed by the business management server 101 to the mobile terminal 105 carried by each staff member. At this time, the distributed operation list contains only data related to the operation for which the staff member is responsible. That is, in order to prevent erroneous operations and to keep security, referencing operation data for other staff members is inhibited. However, operation data for any other staff member maybe downloaded into the mobile terminal 105 for reference.

Labels for two-dimensional codes with corresponding facility data embedded therein are attached to the gas meter 106 and supply facility 107 installed at an operation site.

At the operation site, the operation staff member selects an operation target (the gas meter, the supply facility, or the like) from the operation list on the mobile terminal 105 and then loads, into the mobile terminal 105, the two-dimensional code (for example, a QR code) attached to the gas meter 106 or supply facility 107 on which the operation staff member is to perform an operation.

The mobile terminal 105 transmits the selected operation target data and facility data in the loaded two-dimensional code to the business management server 101. The business management server 101 matches the received operation target data against the facility data to determine whether the operation target data and the facility data correctly correspond to each other (whether the loaded two-dimensional code actually relates to the gas meter or supply facility on which the operation staff member is to perform the operation).

When the operation target data and the facility data are correctly matched, the business management server 101 transmits operation detail data to the mobile terminal 105. For the delivery business, the operation detail data is the number of gas cylinders to be delivered. For the meter reading business, the operation detail data is meter reading data input screen data. For the safety inspection business, the operation detail data is input screen data on survey results. For each type of business, the operation detail data is created based on the latest data when the correct match is found.

The operation staff member performs the operation based on the operation detail data received by the mobile terminal 105 and transmits operation result data to the operation management server 101 via the mobile terminal 105.

The operation management server 101 receives and stores the operation result data. Then, the operation result data can be browsed via the client computer 103 or the mobile terminal 105.

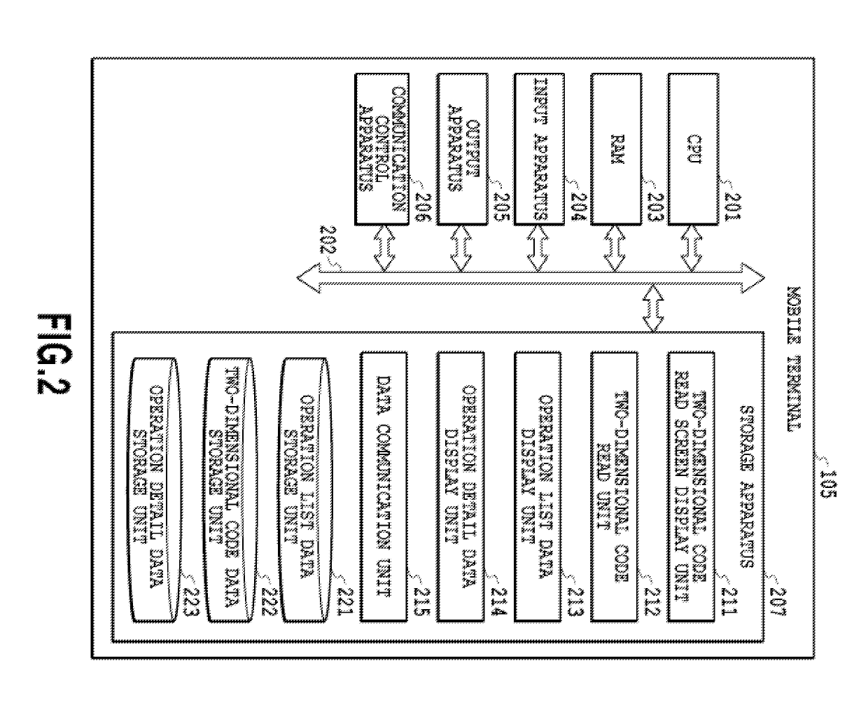

Now, with reference to a block diagram in FIG. 2, a configuration of the above-described mobile terminal 105 will be described in detail.

The mobile terminal 105 is configured such that a CPU 201 couples via a system bus 202 to a RAM 203, an input apparatus 204, an output apparatus 205, a communication control apparatus 206, and a storage apparatus 207 including a nonvolatile storage medium (ROM, HDD, or the like). The storage apparatus 207 includes a program storage area in which a software program providing functions according to the present invention is stored and a data storage area in which data used for or created by the software program is stored. Unit in the program storage area described below are actually independent software programs and routines or components thereof. These are invoked from the storage apparatus 207 by the CPU 201, loaded into a work area in the RAM 203, and sequentially executed to provide functions.

Only those of the storage unit provided in the data storage area in the mobile terminal 105 which are related to the present invention are as follows: an operation list data storage unit 221, a two-dimensional code data storage unit 222, and an operation detail data storage unit 223. Each of the storage unit is a given storage area secured in the storage medium 207.

The operation list data storage unit 221 stores data on an operation schedule. For the delivery business, the operation list data is delivery due dates, delivery destination supply facility names, delivery destination addresses, delivery counts, data on supply facilities that are delivery targets, and the like. The delivery due date can be calculated as a result of prediction of the amount of LP gas remaining in a gas cylinder based on the actual amount of gas previously used by each customer, the result of meter reading of the gas meter at the customer's home, and the actual delivery count. Furthermore, for the housing complex, the delivery destination supply facility name is the name of a condominium (the gas cylinder and the customer are in a one-to-many relation). On the other hand, when the gas cylinder and the customer are in a one-to-one relation, the delivery destination supply facility name may be the name of the customer. For the meter reading business, the operation list data is a meter reading due date determined based on the last meter reading date, customer data, and the like. For the safety inspection business, the operation list data is a safety inspection due date based on a survey term according to the relevant act, customer data, and the like. In the one embodiment, for the operation lists, only relevant data is downloaded to the operation staff member carrying the mobile terminal and stored in the operation list data storage unit 221, for example, in order to prevent erroneous operations and to ensure security.

The two-dimensional code data storage unit 222 stores two-dimensional code data in which facility data on the gas meter 106 or the supply facility 107 is embedded. In the one embodiment, the two-dimensional code data storage unit 222 stores a “facility classification” that indicates whether the facility is a gas meter or a supply facility, a “meter company number” that is an identifier unique between the gas meter and the supply facility, a “manufacturer code” that is a unique identifier for the manufacturer of the gas meter or the supply facility, a “model type” that is indicative of a model type, and a “serial number” that is indicative of a manufacture number. A “parent/child classification” may be, for example, “0” for the gas cylinder and “1” for the supply facility. Furthermore, the “meter company number” is a code with a fixed length corresponding to a mixture of the “manufacturer code”, the “model type”, and the “serial number”.

The operation detail data storage unit 223 stores operation detail data downloaded from the business management server 101 after the loaded two-dimensional code has been correctly matched. For the delivery business, the operation detail data is, for example, the delivery scheduled count of the gas cylinder indicated by the loaded two-dimensional code. For the meter reading business, the operation detail data is the meter reading data input screen data on the gas meter indicated by the loaded two-dimensional code. For the safety inspection business, the operation detail data is, for example, the input screen data on survey results for the gas meter or the supply facility indicated by the loaded two-dimensional code. For each type of business, the operation detail data is created based on the latest data when the correct match is found. Thus, for example, the operation detail data for the delivery business may be indicative of a cylinder count different from the scheduled delivery count of the gas cylinder at the stage of operation list creation (that is, the latest cylinder count at the time of operation detail data creation).

Only those of the unit of the software program stored in the program storage area in the mobile terminal 105 which are related to the present invention are as follows: two-dimensional code read screen display unit 211, two-dimensional code read unit 212, operation list data display unit 213, operation detail data display unit 214, and data communication unit 215.

The two-dimensional code read screen display unit 211 acquires two-dimensional code read screen data from a storage unit (not depicted in the drawings) on the business management server 101 or the mobile terminal 105 and displays a two-dimensional code read screen on the output apparatus 205 of the mobile terminal 105.

When the two-dimensional code read screen is displayed and the mobile terminal 105 is ready to accept reading of the two-dimensional code, the operation staff member uses the two-dimensional code read unit 212 to load the two-dimensional code attached to the gas meter 106 or the supply facility 107. The loaded two-dimensional code is converted into digital data, which is then stored in the two-dimensional code data storage unit 222.

The operation list data display unit 213 acquires operation list data distributed by the business management server 101 and stored in the data storage unit 221, and displays the operation list data on the output apparatus 205 of the mobile terminal 105.

The operation detail data display unit 214 displays, on the output apparatus 205 of the mobile terminal 105, operation detail data for which the correct match has been found for the loaded two-dimensional code and which has been pre-downloaded from the business management server 101 and stored in the operation list data storage unit 221.

The data communication unit 215 transmits the two-dimensional code data and the like to the business management server 101. Furthermore, the data communication unit 215 receives operation list data and the like created by the business management server 101 and stores the operation list data and the like in the storage unit of the mobile terminal 105.

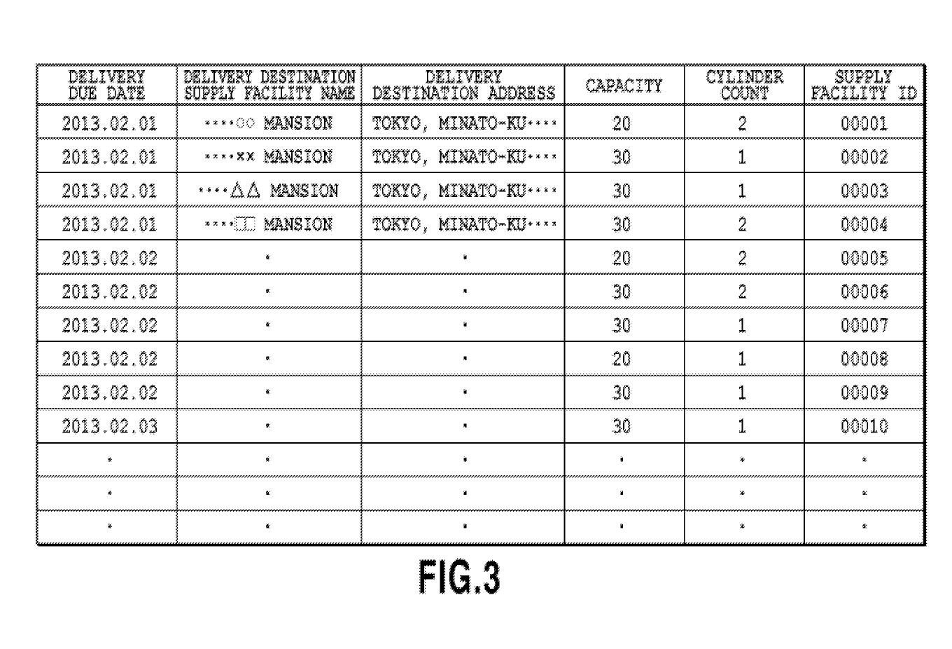

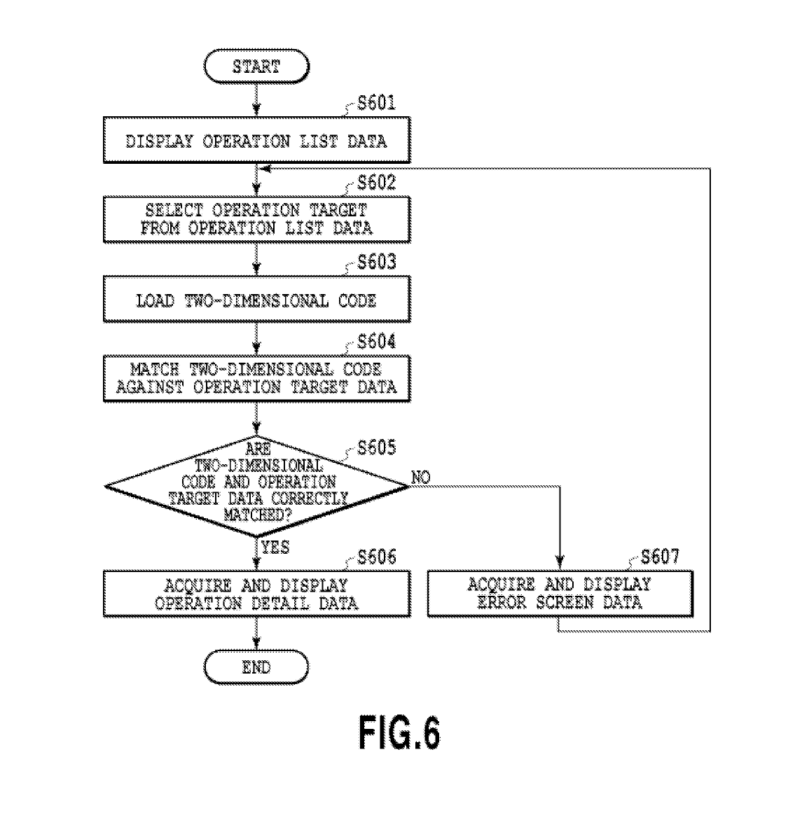

Now, a flow of processing according to the one embodiment of the present invention will be described with reference to a flowchart in FIG. 6 and tables in FIGS. 3 to 5.

FIG. 6 is a flowchart illustrating a process of distributing the operation list, loading the two-dimensional code, and downloading the operation detail data according to the one embodiment of the present invention. In this case, the process will be described taking the delivery business as an example. In step 601, the mobile terminal 105 displays thereon the operation detail data which has been distributed by the business management server 101 and pre-downloaded into the mobile terminal 105. In the one embodiment, the operation list data is list data such as the delivery due date, the delivery destination supply facility name, the delivery destination address, the capacity and number of gas cylinders to be delivered, and the supply facility ID that identifies the supply facility such as the gas cylinder, as depicted in FIG. 3. The data is displayed on the mobile terminal 105, for example, so as to be sorted in an order of the delivery due date. That is, the operation list data is operation schedule data for a given period (for example, one week). The deliveryman, who is the operation staff member, performs the operation based on the operation list data. In an alternative embodiment, the operation list can be created on a daily batch basis during the nighttime of the preceding day or the like and may be a day's operation data for each operation staff member.

The deliveryman visits an operation site based on the operation list data, and at the operation site, selects an operation target from the operation list data via the mobile terminal 105 (step 602). In the one embodiment, the deliveryman performs the selection by tapping, with the finger, the operation target (delivery destination supply facility name or the like) on the operation list data displayed on the mobile terminal 105.

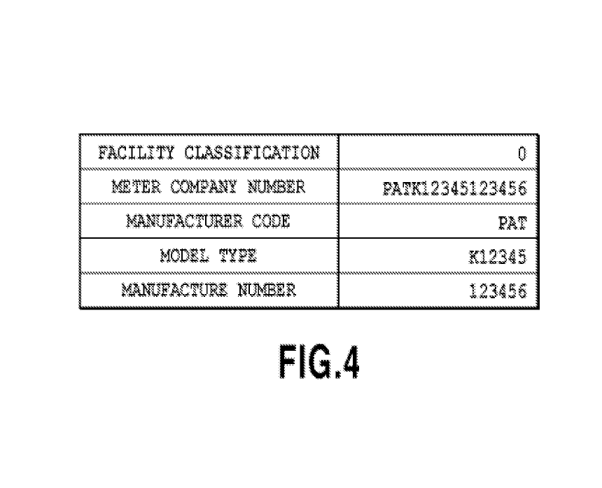

In response to the selection of the operation target on the operation list data, the mobile terminal 105 displays the two-dimensional code read screen. The deliveryman uses the read unit of the mobile terminal 105 to load the two-dimensional code attached to the supply facility such as the gas cylinder which is the facility on which the deliveryman is to perform the operation (step 603). In this regard, the two-dimensional code read screen may be pre-stored in the mobile terminal 105 or downloaded from the business management server 101. In the one embodiment, the loaded two-dimensional code is the facility classification indicating whether the facility is a gas meter or a supply facility, the meter company number that is an identifier unique between the gas meter and the supply facility or the like, the manufacturer code that is a unique identifier for the manufacturer of the gas meter or the supply facility or the like, the model type of the gas meter or the supply facility or the like, and the serial number that is indicative of the manufacture number of the gas meter or the supply facility or the like, as depicted in FIG. 4. The two-dimensional code is separated into pieces with delimiters such as commas, and the pieces are embedded in the two-dimensional code.

The mobile terminal 105 transmits the loaded two-dimensional code data and data on the selected operation target facility to the business management server 101, and the business management server 101 matches the loaded two-dimensional code data and data on the selected operation target facility against each other (step 604). The match is determined by checking whether the selected operation target facility is associated with the loaded two-dimensional code data based on the data stored in the business management server 101. In the alternative embodiment, the mobile terminal 105 may perform the matching on the mobile terminal 105 by pre-downloading the identifier (for example, the meter company number) in the two-dimensional code data associated with the operation target, into the mobile terminal 105 as operation list data.

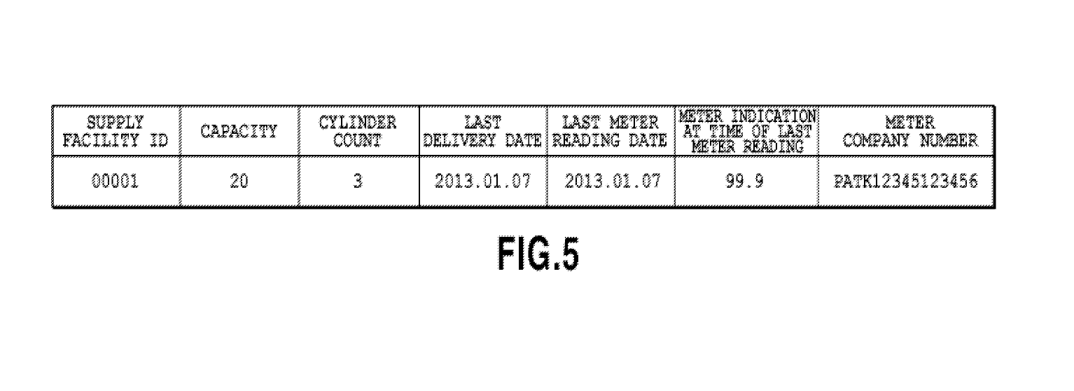

In step 604, when the selected operation target and the loaded two-dimensional code data facility are correctly matched, the process proceeds to a Yes route of step 605, where the mobile terminal 105 acquires and displays the operation detail data (step 606). In the one embodiment, the operation detail data is the capacity and number of gas cylinders to be delivered, last delivery data, meter reading data, and the like which are related to the correctly matched operation target facility as depicted in FIG. 5. In this regard, it should be appreciated that the “cylinder count” of the gas cylinders in FIG. 5 is not necessarily equal to the “cylinder count” in the operation list data in FIG. 3 due to a difference in data creation timing. This is because the operation data is re-created based on data obtained at a time closer to the time of the performance of the operation. The deliveryman performs the operation based on the operation detail data. Although not depicted in the drawings, in the one embodiment, the mobile terminal 105 can transmit operation completion instruction data to the business management server 101 after the performance of the operation is complete.

On the other hand, in step 604, when the selected operation target and the loaded two-dimensional code data facility are not correctly matched, the process proceeds to a No route of step 605, where the mobile terminal 105 displays information indicating that the correct match has not been found, on the mobile terminal 105 as an error screen (step 607). The error screen may be pre-stored in the mobile terminal 105 or downloaded from the business management server 101. Furthermore, after the error screen is displayed, the process may return to step 602 to start all over again with the selection of the operation target.

The flow of the series of process steps in the delivery business has been described, but it should be appreciated that the description also applies to the meter reading business and the safety inspection business. For example, for the meter reading business, the mobile terminal 105 displays the meter reading list distributed by the business management server 101, on the mobile terminal 105 (step 601). Then, the meter reader selects an operation target (gas meter or the like) on the meter reading list (step 602). Furthermore, the meter reader loads the two-dimensional code attached to the gas meter on which meter reading is to be performed (step 603). The selected operation target and the loaded two-dimensional code are matched against each other (step 604). When the selected operation target and the loaded two-dimensional code are correctly matched (step 605), the mobile terminal 105 acquires operation detail data including last meter reading data and displays the operation detail data on the mobile terminal 105 (step 606).

On the other hand, for the safety inspection business, the mobile terminal 105 displays the safety inspection list distributed by the business management server 101, on the mobile terminal 105 (step 601). Then, the safety inspector selects an operation target (the gas meter, the supply facility, or the like) on the safety inspection reading list (step 602). Furthermore, the safety inspector loads the two-dimensional code attached to the gas meter or supply facility on which the safety inspector is to perform a safety operation (step 603). The selected operation target and the loaded two-dimensional code are matched against each other (step 604). When the selected operation target and the loaded two-dimensional code are correctly matched (step 605), the mobile terminal 105 acquires operation detail data including inspection items generated based on the customer data and the facility data and displays the operation detail data on the mobile terminal 105 (step 606).

1. A method of loading a two-dimensional code and outputting operation detail data on liquid petroleum (LP) gas delivery business, the method comprising:
outputting, by a first computer, operation list data that is operation schedule data on the LP gas delivery business including a plurality of pre-downloaded and stored operation target data;
receiving, by the first computer, one of the operation target data selected by a user operation from the output operation list data;
reading, by the first computer, a two-dimensional code attached to an operation target facility and receiving the two-dimensional code as two-dimensional code data;
matching, by the first computer, the selected operation target data against the received two-dimensional code data; and
when the selected operation target data and the received two-dimensional code data are correctly matched, downloading, from a second computer, and outputting, by the first computer, operation detail data that is detail data of the selected operation target data, the operation detail data being capacity and cylinder count of a gas cylinder to be delivered related to the operation target facility.

2. The method according to claim 1, wherein the operation detail data is created after the selected operation target data and the received two-dimensional code data are correctly matched.

3. The method according to claim 1, further comprising when the selected operation target data and the received two-dimensional code data fail to be correctly matched, outputting, by the first computer, information indicating that the selected operation target data and the received two-dimensional code data fail to be correctly matched.

4. The method according to claim 1, wherein the two-dimensional code is a quick response code.

5. The method according to claim 2, wherein the two-dimensional code is a quick response code.

6. The method according to claim 3, wherein the two-dimensional code is a quick response code.

7. A computer-readable storage medium that stores a computer-executable instructions allowing execution of a method for loading a two-dimensional code and outputting operation detail data on liquid petroleum (LP) gas delivery business, the method comprising:
outputting operation list data that is operation schedule data on the LP gas business including a plurality of pre-downloaded and stored operation target data;
receiving one of the operation target data selected by a user operation from the output operation list data;
reading a two-dimensional code attached to an operation target facility and receiving the two-dimensional code as two-dimensional code data;
matching the selected operation target data against the received two-dimensional code data; and
when the selected operation target data and the received two-dimensional code data are correctly matched, downloading, from a sever computer, and outputting operation detail data that is detail data of the selected operation target data, the operation detail data being capacity and cylinder count of a gas cylinder to be delivered related to the operation target facility.

8. A computer that loads a two-dimensional code and outputs operation detail data on liquid petroleum (LP) gas delivery business, the computer being configured to:
output operation list data that is operation schedule data on the LP gas business including a plurality of pre-downloaded and stored operation target data;
receive one of the operation target data selected from the output operation list data by a user operation;
read a two-dimensional code attached to an operation target facility and receiving the two-dimensional code as two-dimensional code data;
match the selected operation target data against the received two-dimensional code data; and
when the selected operation target data and the received two-dimensional code data are correctly matched, download, from a sever computer, and output operation detail data that is detail data of the selected operation target data, the operation detail data being capacity and cylinder count of a gas cylinder to be delivered related to the operation target facility.
